(19) United States
(12) Patent Application Publication
(10) Pub. No.: US 2025/0182011 A1
(43) Pub. Date: Jun. 5, 2025

(54) CLOUD-BASED REMOTE VIDEO PRODUCTION PLATFORM

(71) Applicant: Advanced Image Robotics, Inc., Carlsbad, CA (US)

(72) Inventors: Nick NORDQUIST, Carlsbad, CA (US); Jeff DEBROSSE, Carlsbad, CA (US)

(21) Appl. No.: 18/843,668

(22) PCT Filed: Mar. 3, 2023
(86) PCT No.: PCT/US2023/014542

§ 371 Date: Sep. 3, 2024

Related U.S. Application Data
(60) Provisional application No. 63/316,332, filed on Mar. 3, 2022.

(51) Int. Cl. G06Q 10/0631; G06F 9/451; G11B 27/031; H04N 5/222; H04N 5/268

(52) U.S. Cl. CPC G06Q 10/063116; G06F 9/451; H04N 5/2224; H04N 5/268; G11B 27/031

(57) ABSTRACT

A platform and a process for creating and modifying video editing workflows employs an object-oriented cloud-based system. The system simplifies the video editing workflow creation and editing process by providing the user with a definable set of inputs definable job assignments related to specific digital assets.

### RELATED APPLICATIONS

The present application claims the benefit of the priority of U.S. Provisional Application No. 63/316,332, which is incorporated herein by reference in its entirety.

### FIELD OF THE INVENTION

The present invention relates to a method and platform for creating and managing video production workflows from conception to completion.

### BACKGROUND

Multi-camera video production is equipment and labor intensive. Preparing for a broadcast requires extensive setup time and labor. Truckloads of equipment are often filled with dedicated audio and video (A/V) specific hardware along with a team of highly trained personnel who are required to convene on-location in order to create a video broadcast. Most A/V equipment by its nature is designed to be operated hands-on on-site at a live event site or in a dedicated production studio.

Economic and efficiency considerations, including project budgets and skilled labor shortages, are driving a need to facilitate remote collaboration among video crew members in addition to remote operation distant from the actual shoot location. While limited remote control capabilities may exist for some traditional A/V equipment, most implementations are highly constrained in functionality and require numerous intermediary devices to adapt to a remote use case for which the equipment was never intended. These factors make remote production with an offsite crew complex, costly, and difficult to accomplish.

Video editing involves a complex series of steps and processes that starts with the identification of the digital asset, i.e., the digital file that contains the content to be incorporated into the video, and ends with a final production version. This process includes the movement of digital assets from one device to another to finally reach the person that will edit the video file. The assignment to an editor, and subsequently to a project, and finally tracking their progress and providing final acceptance has traditionally required one or more people to create ad-hoc lists of statuses and assignments which tend to be error-prone and inadequate for providing status updates in a timely manner.

Pre-production, production, and editing/post-production are all touched by growing number of digital video assets using a limited number of people to manage the full process. This increased growth in the creation of digital content has created a backlog of content that is difficult to manage and assign to specific projects and personnel—pre-production, production, and editing/post-production are all touched by growing number of digital video assets.

The industry has recently begun to adopt Information Technology (IT) to transport video, audio and control signals over Internet Protocol (IP)-based infrastructure. In addition to being beneficial to remote production use cases, IT based workflows have tremendous potential cost and efficiency benefits. However, widespread adoption is hampered by the inherent limitations of legacy A/V equipment and production methods as well as the technical knowledge required to conform to IP standards. Video technicians are accustomed to plugging A/V cables into dedicated A/V devices to accomplish dedicated A/V tasks. Transitioning to plugging IT devices into IP networks comes with knowledge gaps and hurdles for these personnel.

Existing applications suffer many drawbacks that may hinder the user's ability to have timely and detailed awareness of the status of projects and files. These applications are typically only able to apply media management functions, resulting in awkward movement of digital assets from one system to the next in order to complete the video production workflow process. This results in the need for multiple systems to support a user's need to take content from a recording source and, through a series of file copying between separate systems, end up with a final production version of their digital assets. This weakness exists in current video production workflows, allowing for discontinuity between file names, projects, and associated data. What is required is a system that keeps the relationships intact and applies changes in a cascading manner. This is similar to the data quality concept in modern database management systems called “referential integrity,” where changes to data in one location are automatically reflected in other related records.

All of these disadvantages work together to increase the difficulty of creating and tracking assets, jobs, and statuses. Accordingly, a need exists within the field for novel orchestration layer management capabilities for streamlining the process of video production, for ease of use and to facilitate collaboration. An ecosystem that takes full advantage of IT workflows while being easily navigable by legacy A/V technicians is desperately needed.

### SUMMARY

The inventive cloud-based video production platform transforms the traditional video production model by converting video, audio, and control signals to IP protocols directly on a camera platform. One example of an appropriate camera platform is described in International Publication No. WO 2021/195641, referred to as the “AIRstation™”, the disclosure of which is incorporated herein by reference. Within the inventive video production platform, which may be referred to as the “AIRcloud™ system”, the IP signals are connected via wired and/or wireless connections to virtual computing resources. This approach allows the entire video production ecosystem to be virtualized. Ubiquitous IP infrastructure can be used to transport the signals, allowing dedicated A/V hardware to be converted into on-demand virtual compute resources. This approach drastically reduces the on-location equipment footprint, the personnel required to set it up, and creates the opportunity for a distributed workforce. In this system, the equipment can be operated locally, remotely, or a combination thereof, by way of a robust internet connection.

In order to effectively deploy a video over IP ecosystem, a comprehensive easy-to-use management system is required. The inventive AIRcloud™ system is an integrated tool for IP-based video production. It allows for operation of A/V and IT resources remotely, defining user roles, enabling permissions, provisioning cameras, compute resources, and storage, managing media, as well as managing accounts and payments. It is an ecosystem that encompasses management and use of the entire pre-production, production, and post-production A/V workflow in a cloud based environment.

The inventive system employs software components that include multiple individual smaller software modules, relational databases and network-based connectivity. User account management, user access permissions, user groups and job assignments are defined in the system and used to create and edit video production workflows. One of the key improvements provided by the inventive platform is that digital asset information, i.e., information about the contents of a digital file and how it was created, which may include file metadata, camera and lens metadata, IMU and encoder metadata, as well as user metadata is automatically captured as it is generated. The modularity of this system provides for automatically directing the uploaded content to externally or internally connected services, such as transcription systems, or computer vision analysis for object identification, which can automatically perform functions on the digital asset prior to, or after, an editor makes changes to the digital asset. Digital assets are assigned to one or more users through the creation of project jobs. During the post-production process, when one or more digital assets are identified as requiring an editor to make specific changes to the asset, the digital asset is assigned to a user-defined project job by a manager. This project job is further assigned to an editor. The editor may change the status of the project job when they begin the editing process and/or when their edits are complete. This will submit the project job for review. A manager may then review the digital asset's edits and take other actions such as accepting the work, changing the status, and downloading the asset. If the work has not been accepted as complete, the manager may provide new instructions or comments, change the status and they may be notified when the editor has completed the revisions. This iterative process can continue across revisions until the digital asset has been accepted.

One of the important innovations of the AIRcloud™ system is that it enables automation of traditionally manual tasks. Traditional broadcast workflows demand most functions be executed manually by human operators. In contrast, the AIRcloud™ system allows for many of these functions to be automated across the pre-production, production, and post-production workflow.

In one aspect of the inventive system, a platform for managing video production workflows includes: an interface in communication with a network, the interface configured for entry of and transmission of instructions to and receiving information from a plurality of modules, each module in communication with the network, the modules comprising: an admin module configured to distribute instructions to other modules and receive status information from other modules; an offsite camera control module; a remote editing module; a remote production module; a client review and collaboration module; and a distribution/broadcast module; and at least one camera in communication with the network; wherein the admin module is used by a project manager to assign jobs, access and distribute digital assets, and to communicate with platform users. The platform users may include one or more administrator, producer, technical director, camera operator, audio technician, graphics operator, and client. In some embodiments, instructions and information may be configured to trigger one or more automated action within one or more of the plurality of modules and the at least one camera. The plurality of modules may further include a machine learning module configured for artificial intelligence (AI)-assisted asset identification and categorization. The camera may be configured for control via a remotely-located camera operator.

In another aspect of the invention, a platform for managing video production workflows includes: an interface in communication with a network, the interface configured for entry of and transmission of instructions to and receiving information from a plurality of modules, each module in communication with the network, the modules comprising: an admin module configured to provide instructions to other modules and receive status information from the other modules; an offsite camera control module; a remote editing module; and at least one digital file source in communication with the network; wherein the admin module comprises a user interface (UI) that is used by a project manager to assign jobs, access and distribute digit assets, and to communicate with platform users, and wherein the interface is further configured to deliver a completed video production to a content distribution network (CDN) in communication with the network. The network may include a combination of wired and wireless connections.

The platform users may include one or more of an administrator, the project manager, a producer, a technical director, a camera operator, an audio operator, on-screen or voice-over talent, and a client. Instructions and information are configured to trigger one or more automated action within one or more of the plurality of modules and the at least one digital file source. The at least one digital file source generates one or more digital file comprising one or a combination of an image, a series of images, an audio, metadata describing the image, the series of images, or the audio. The metadata may include one or a combination of identifiers consisting of name, date, time, format, client, project, subject matter, location, settings under which the one or more digital file was created, editing history, editing permissions, and copying permissions. In some embodiments, the wherein the metadata may include one or more of camera settings, camera lens settings, camera robotic controller settings, camera sensor readings, and audio levels.

In some embodiments, the plurality of modules includes a machine learning module configured for artificial intelligence (AI)-assisted asset identification and categorization. The machine learning module may be configured to extract information from the one or more digital file and execute an analysis comprising one or more of object detection, keyword tagging, face detection, video segment identification, computer vision analysis of human performance, body mechanics, emotion perception, and audio analysis. In other embodiments, the machine learning module may be further configured to extract audio information from the one or more digital file and execute an analysis of a speech component of the audio information for automatic speech to text transcription or to generate a keyword or a command for further action.

The plurality of modules further comprises a remote production module configured for managing broadcast of the video production to the CDN. A client review and collaboration module configured to provide edited content to a client to review and accept or reject the edited content prior to delivering the completed video production.

In some embodiments, the at least one digital file source is a camera configured for control via a remotely-located camera operator, wherein the remotely-located camera operator is in communication with the interface. In other embodiments, the at least one digital file source is an audio recorder, which may be incorporated into a camera. The at least one digital file source may be a plurality of digital file sources, wherein each digital file source is associated with a unique code for establishing a link to a predetermined site plan. The unique code may be configured for scanning by a platform user's mobile device, wherein scanning the unique code causes the predetermined site plan to be displayed on the mobile device, wherein an assigned position of the digital file source associated with the unique code is displayed within the predetermined site plan.

In some embodiments, the admin module may be further configured for the project manager to assign access limits for controlling access to elements within the platform and the digital assets by each user as required for the platform user's assigned job. The admin module may be further configured to collect status information for platform components and generate a master status dashboard (MSD) to display status and settings for one or more of the at least one digital file source, communications, and performance data in real time. In some implementations, the status and settings displayed on the MSD are one or more of camera settings, CPU status, connection conditions, stream health, available storage, recording status indicator, and uptime.

In some embodiments, the remote editing module may be configured to manage a workflow for jobs comprising editing, reviewing and finalizing the project, wherein the remote editing module is further configured to deliver a digital asset to a designated platform user when a job is assigned to the designated platform user.

In still another aspect of the invention, a method for managing video production workflows over a network, the method includes providing an interface configured for entry of and transmission of instructions to and receiving information from a plurality of modules, each module in communication with the network, the modules comprising: an admin module configured to provide instructions to other modules and receive status information from the other modules; an offsite camera control module; a remote editing module; and at least one digital file source in communication with the network; wherein the admin module comprises a user interface (UI) that is used by a project manager to assign jobs, access and distribute digit assets, and to communicate with platform users; and delivering a completed video production to a content distribution network (CDN) in communication with the network. The network may include a combination of wired and wireless connections.

The platform users may include one or more of an administrator, the project manager, a producer, a technical director, a camera operator, an audio operator, and a client. Instructions and information are configured to trigger one or more automated action within one or more of the plurality of modules and the at least one digital file source. The at least one digital file source generates one or more digital file comprising one or a combination of an image, a series of images, an audio, metadata describing the image, the series of images, or the audio. The metadata may include one or a combination of identifiers consisting of name, date, time, format, client, project, subject matter, location, settings under which the one or more digital file was created, editing history, editing permissions, and copying permissions. In some embodiments, the metadata may include one or more of camera settings, camera lens settings, camera robotic controller settings, camera sensor readings, and audio levels.

In some embodiments, the plurality of modules includes a machine learning module configured for artificial intelligence (AI)-assisted asset identification and categorization. The machine learning module may be configured to extract information from the one or more digital file and execute an analysis comprising one or more of object detection, keyword tagging, face detection, video segment identification, computer vision analysis of human performance, body mechanics, emotion perception, and audio analysis. In other embodiments, the machine learning module may be further configured to extract audio information from the one or more digital file and execute an analysis of a speech component of the audio information for one or more of automatic speech to text transcription and generating a keyword or a command for further action.

The plurality of modules further comprises a remote production module configured for managing broadcast of the video production to the CDN. A client review and collaboration module configured to provide edited content to a client to review and accept or reject the edited content prior to delivering the completed video production.

In some embodiments, the at least one digital file source is a camera configured for control via a remotely-located camera operator, wherein the remotely-located camera operator is in communication with the interface. In other embodiments, the at least one digital file source is an audio recorder, which may be incorporated into a camera. The at least one digital file source may be a plurality of digital file sources, wherein each digital file source is associated with a unique code for establishing a link to a predetermined site plan. The unique code may be configured for scanning by a platform user's mobile device, wherein scanning the unique code causes the predetermined site plan to be displayed on the mobile device, wherein an assigned position of the digital file source associated with the unique code is displayed within the predetermined site plan.

In some embodiments, the admin module may be further configured for the project manager to assign access limits for controlling access to elements within the platform and the digital assets by each user as required for the platform user's assigned job. The admin module may be further configured to collect status information for platform components and generate a master status dashboard (MSD) to display status and settings for one or more of the at least one digital file source, communications, and performance data in real time. In some implementations, the status and settings displayed on the MSD are one or more of camera settings, CPU status, connection conditions, stream health, available storage, recording status indicator, and uptime.

In some embodiments, the remote editing module may be configured to manage a workflow for jobs comprising editing, reviewing and finalizing the project, wherein the remote editing module is further configured to deliver a digital asset to a designated platform user when a job is assigned to the designated platform user.

### BRIEF DESCRIPTION OF THE DRAWINGS

FIG. 1A is a high level block diagram of basic modules of an embodiment of the inventive platform the AIRcloud™ system; FIG. 1B is an alternative system diagram showing grouping of key tasks within the platform.

FIG. 2A is a diagrammatic view of a main dashboard according to an embodiment of the inventive system.

FIG. 2B is a high level flow diagram illustrating an exemplary sequence of operations for post-production workflow involving the digital asset upload, user assignment, job creation, editing and update processes to create an efficient workflow using the inventive system.

FIGS. 3A-3E illustrate an exemplary sequence for a shoot setup using the inventive system.

FIGS. 4A-4B are sample screenshots of live video/audio routing using the inventive system's routing function.

FIG. 5 is a diagrammatic view of a sample screenshot of a Multiview display with the image received from an assigned camera.

FIGS. 6A-6C are diagrammatic views of sample Multiview features.

FIG. 7 is a diagrammatic view of a sample Program Feed feature according to embodiments of the inventive system.

FIG. 8 is a diagrammatic view of a sample screenshot of a Camera Launchpad feature according to an embodiment of the inventive system.

FIG. 9 is a diagrammatic view of an exemplary process for accessing camera information by scanning a QR code.

FIG. 10 is a diagrammatic view of a sample screenshot of an Edit Setup feature according to an embodiment of the inventive system.

FIG. 11 is a sample screenshot of a Media Asset Management (MAM) feature according to an embodiment of the inventive system.

FIG. 12 provides a sample screenshot of the Master Status Dashboard (MSD) according to an embodiment of the inventive system.

### DETAILED DESCRIPTION OF EMBODIMENTS

The following detailed description provides examples of embodiments of the inventive system with reference to the accompanying drawings.

As used herein, the term “and/or” includes any and all combinations of one or more of the associated listed items. As used herein, the singular forms “a,” “an,” and “the” are intended to include the plural forms as well as the singular forms, unless the context clearly indicates otherwise. As a clarifying example, when an object is recited, unless that object is expressly described as a single object, “one or more object”, “at least one object”, or “a plurality of objects” also falls within the meaning of that term.

Definitions: Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. For further clarity, but not limitation, additional definitions are provided for the following terms:

“User” means a person operating in one of more roles on a project. Users may include Project Managers, Administrators, Producers, Technical Directors, camera operators, audio operators and support personnel who may be authorized to interact with the platform.

“Role” means a job assignment for a project, which, in addition to the Users described above may include, for example, Graphic Operator, Replay Operator, Client, Field Crew, Editor.

“Project” means an event or series of events involving video and/or audio capture and production. “Project” may also include post-production and editing.

“Project manager” means one or more person responsible for planning and execution of a Project, including a Administrators, Producers, Technical Directors.

“Instance” means a computer, machine, or piece of equipment. For example, an “instance” may be a virtual machine in the cloud, a machine at a remote location separated from the shoot site, or a machine on location with the cameras.

“Asset” means any person, camera, gear, computer instance, or digital file associated with a project or user.

“Digital file source” means a device that is the source of an image, video and/or audio file (collectively, “digital file”), and data related thereto, including metadata that describes elements and features of the digital file and how it was created For purposes of this description, “digital file source” includes not only a conventional camera for direct image and/or sound detection/collection, e.g., raw video, but also includes a storage device or other source of a digital file that may have been generated separately in time or as part of independent effort using an independent camera and stored in the storage device, or may be a computer-generated digital file in which a conventional camera was used to generate none of, or only a portion of, the digital file. For example, a pre-existing animation may be digital file.

“Permission” means authorization/access to a protected asset.

“Online” means an asset is available for immediate use.

“Offline” means an asset not available for immediate use.

“Remote” in the context of production and editing means work conducted distant from the event location and/or away from the traditional workplace.

“Broadcast” refers to transmission of AV signals to one or more recipients simultaneously, by wired or wireless means, and includes but is not limited to, over the air and live stream transmission.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are anticipated and, therefore, within the scope of the invention and the claims.

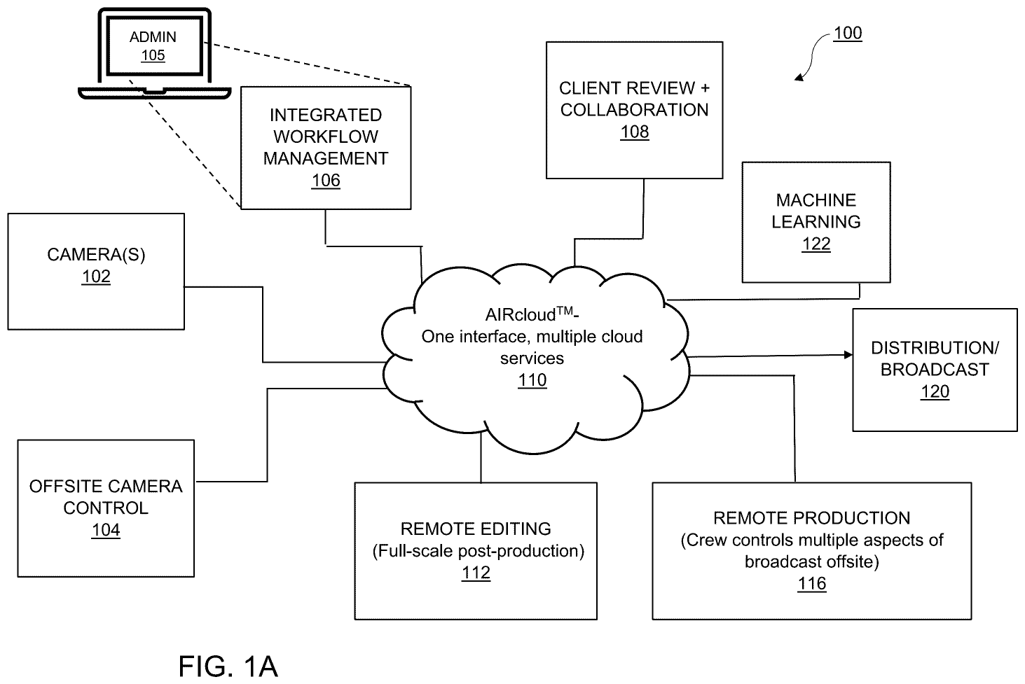

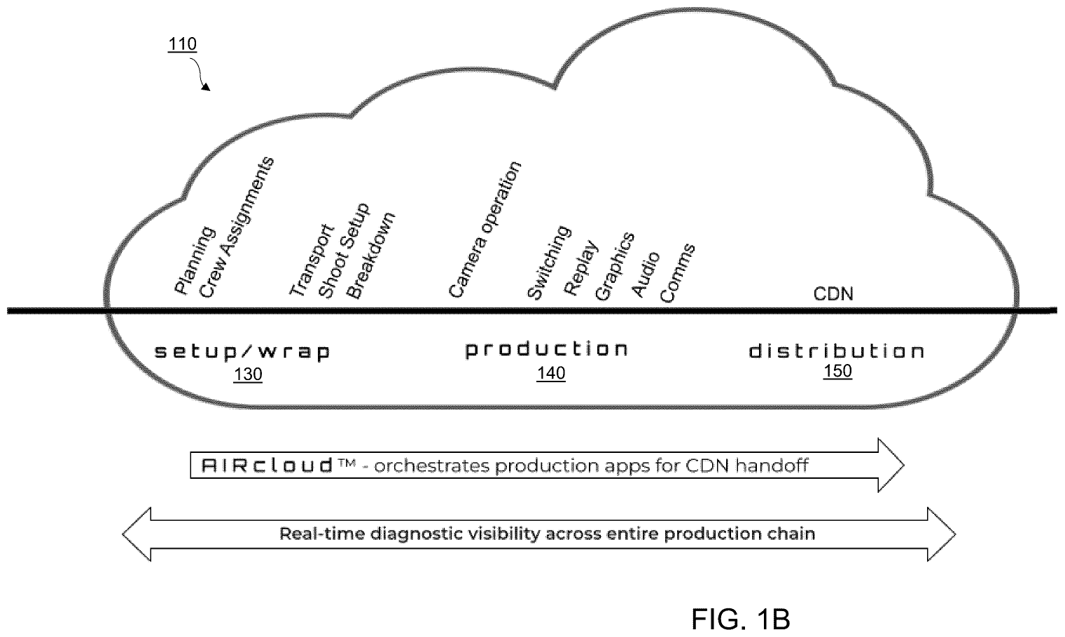

FIG. 1A provides a high level block diagram of the basic elements of an embodiment of the inventive video production platform 100. Central to the platform is the AIRcloud™ interface 110, which provides a single interface for multiple cloud services. Interface 110 provides communication for remote pre-production, production, and post-production, content management, secure storage/archive/retrieval transcode packaging for distribution, and machine learning control assistance and analytics. Interface 110 is in two-way communication with each of the platform modules: camera(s) 102—generally, but not necessarily, multiple cameras, where cameras may include robotic controllers; offsite camera control 104; integrated workflow management 106 which may be accessed via administrator (“admin”) controller 105, e.g., a laptop, tablet, mobile device, desktop computer, workstation or other computing device; client review and collaboration 108; remote editing and post-production 112; remote production 116; where the crew controls multiple aspects of a broadcast from an offsite location; distribution/broadcast 120; and machine learning analytics and assistance 122. The function and details of the various modules will be described below.

FIG. 1B provides a higher level diagram that illustrates grouping of key tasks managed by the inventive AIRcloud™ interface. Interface 110 provides management of modules for facilitating and performing a number of key operation groups within the overall video production sequence ending in delivery for distribution to the content distribution network (CDN). The “setup/wrap” task group 130 includes planning, crew assignments, transport, shoot setup and breakdown, i.e., pre-production. Task group 130 would primarily involve interfacing with the admin module 105 for pre-production activities. The “production” task group 140 includes camera operation, switching, replay, graphics, audio, and comms. Interface 110 would manage modules 102, 104, 108, 112 and 116, then manages the handoff to the CDN for the distribution task 150. Interface 110 provides real-time diagnostic visibility across the entire production chain.

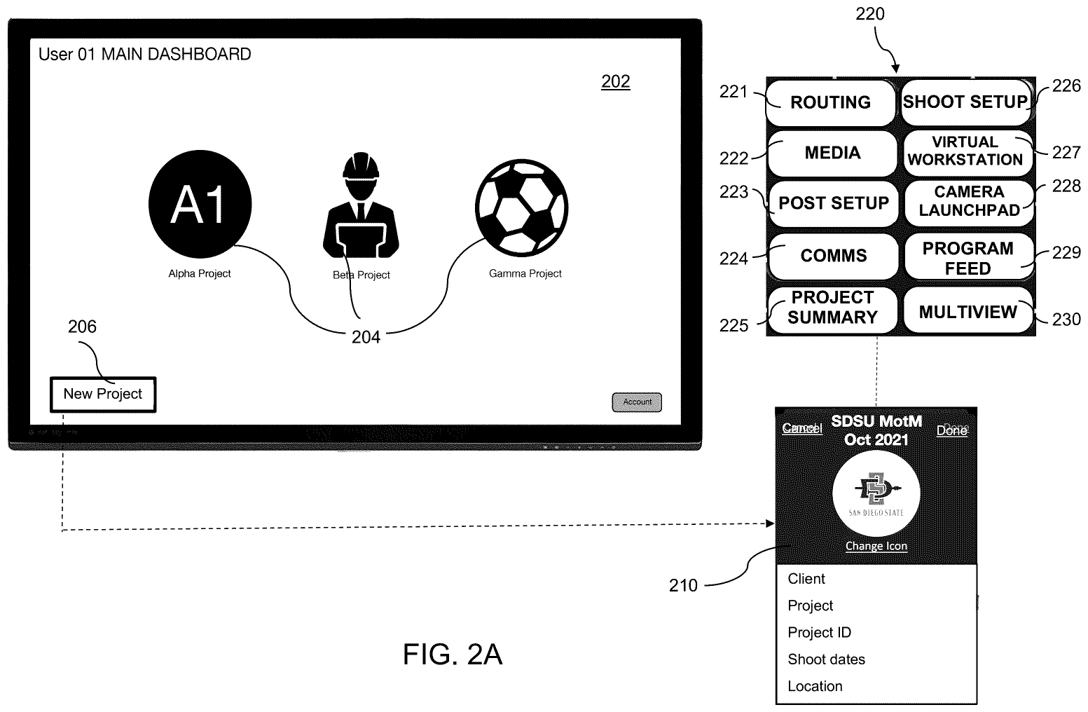

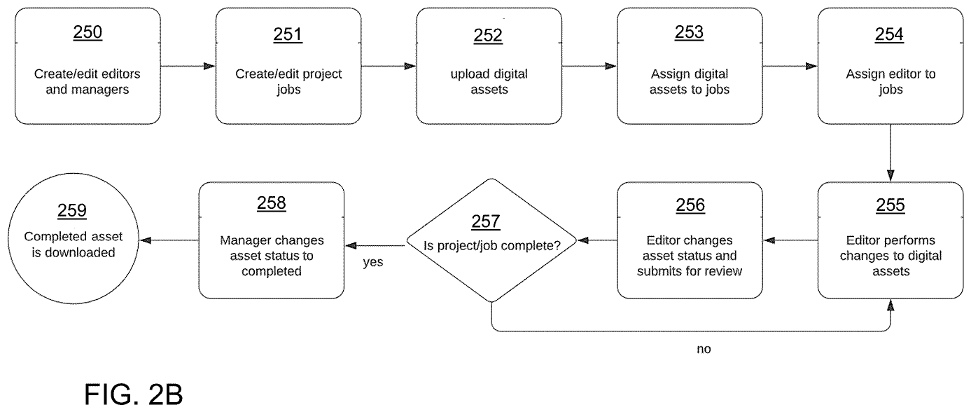

Access to the platform portal begins with a login username and password landing page. The login process may be secured using one or more known authentication methods. Examples of authentication methods include: Single-Sign-On (SSO), Security Assertion Markup Language (SAML), Oauth, and OpenID. Other methods are known to those of skill in the art. This access may be achieved via with the admin controller 105 or any other communication device that is assigned to or associated with a user. In some projects, users may be pre-arranged and already have credentials assigned for logging on to the system. For users who may not yet have an account, a “new user signup” button links to the account creation screen where they enter various information including but not limited to; name, company, email address, nickname, phone number, hometown, etc. The user may upload an image for use as their avatar/icon. If no image is provided, two-character initials can be substituted, or the user may be assigned a user number. Final step is to provide a login password. After approved login, the user will be directed to the platform dashboard, which is diagrammatically shown in FIG. 2A.

The dashboard 202 is the starting point and central hub for users to navigate the various features of the platform portal, which may be referred to as the “AIRcloud™ Portal”. Once a user is assigned a role on a project, one or more associated project icon 204 will appear on their dashboard. The user will then have access to project details, communications with other team members, as well as any features that are accessible via permissions and roles. Permissions are automatically generated based on the user's defined role in the project and can also be customized by an Administrator or Producer.

Project functions may include, but are not limited to, selecting a multiview interface, viewing the program feed, camera control, virtual workstation control, shoot setup configuration, audio/video routing, media asset management, post-production setup and configuration, communications setup and configuration, project detail summary.

In pre-production, to create a new project, an Administrator or Producer selects “new project” by clicking on “New Project” 206 on the dashboard. They can then upload an icon image, if appropriate, and enter various information about the project including but not limited to, project name, client, project ID, shoot date(s), location, an example of which is provided as project box 210. All projects to which a particular user is connected will appear on the dashboard. Selection of a project icon 204 on the dashboard 202 opens up navigation menu 220 for the project. Each of buttons 221-230 within menu 220 takes the user to a different module or function within the overall system, each of which will be described below in more detail.

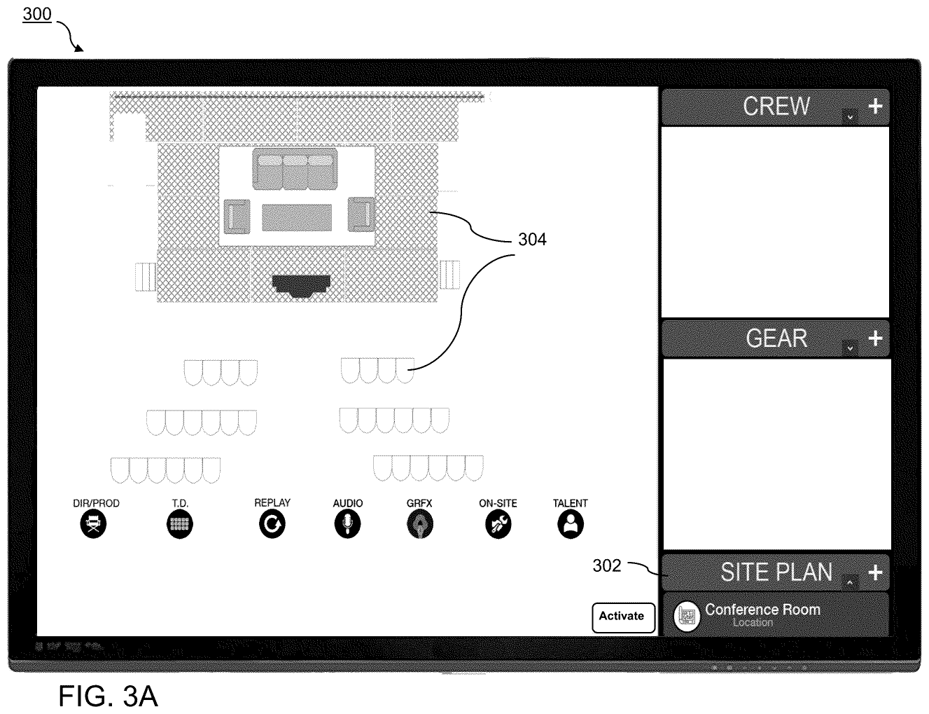

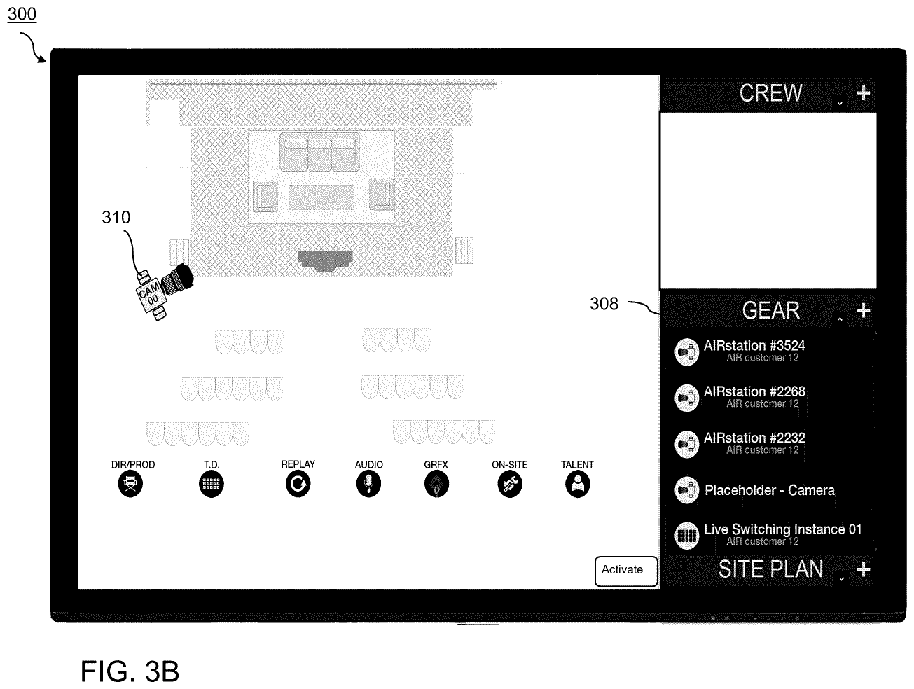

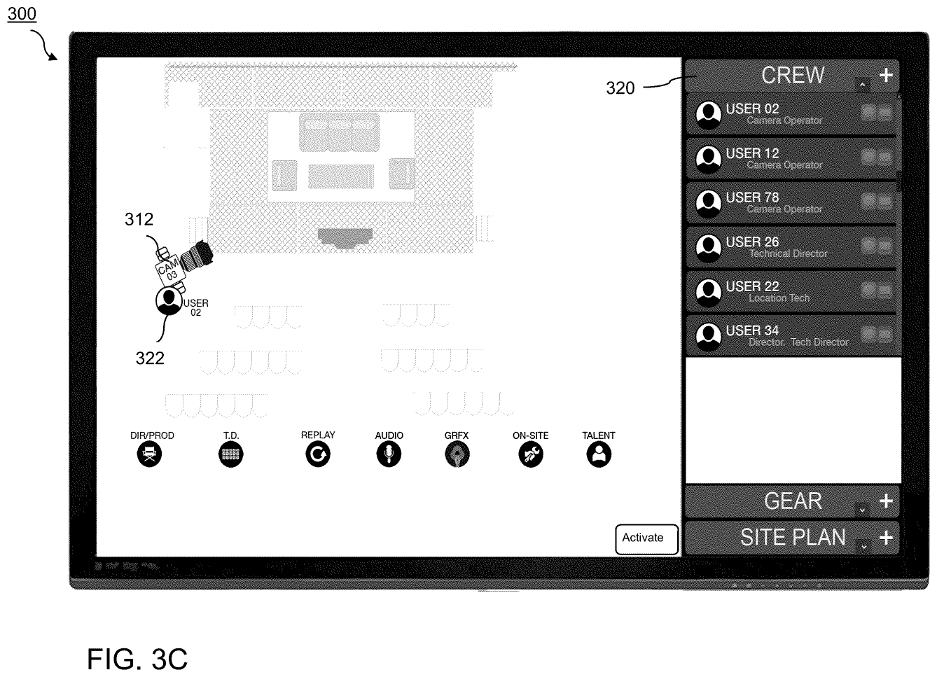

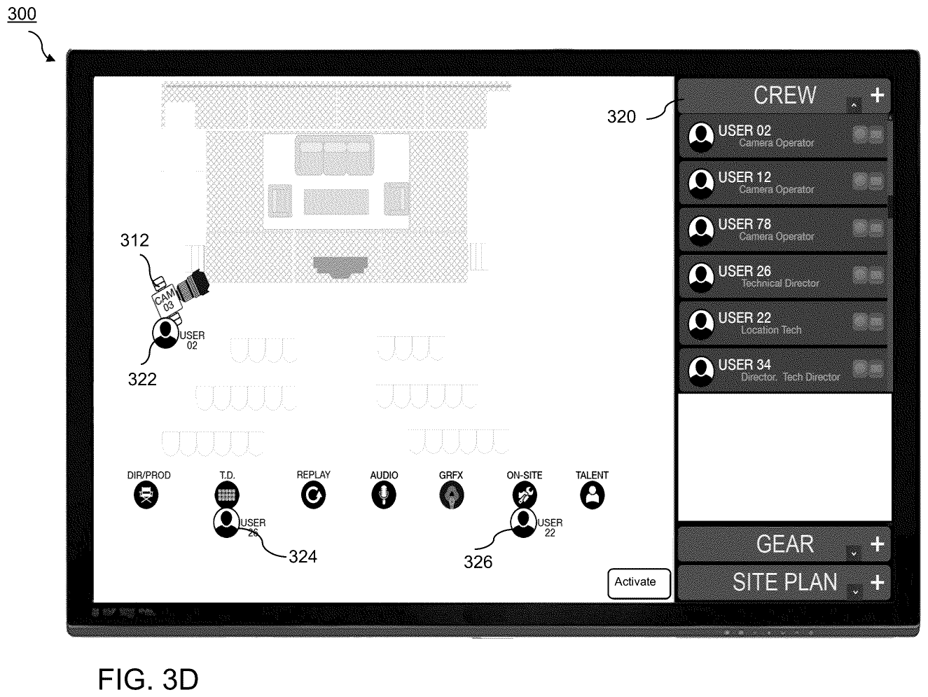

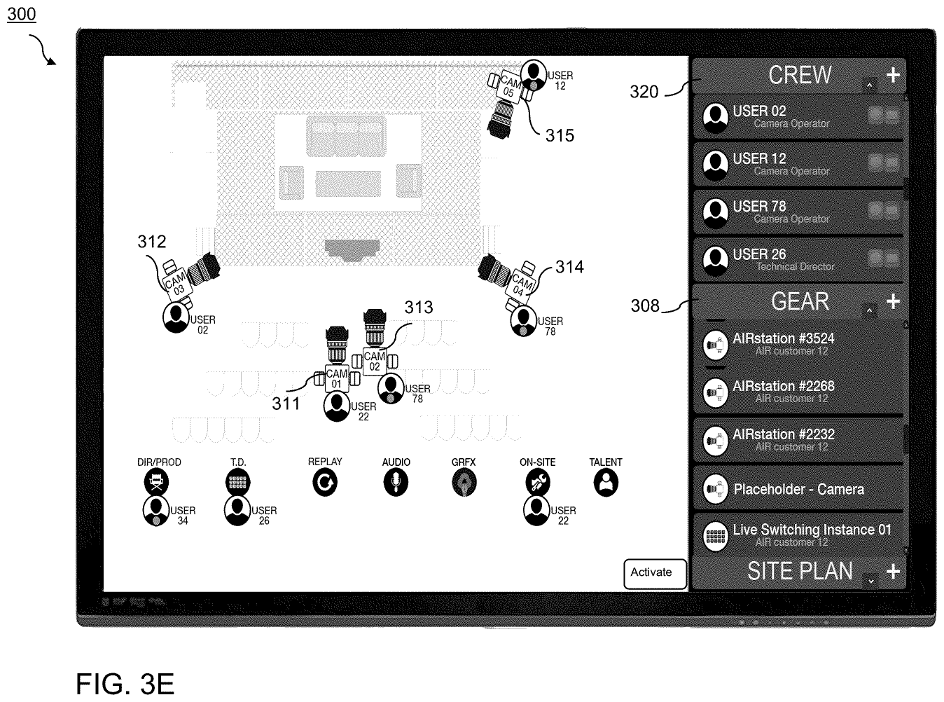

The “Shoot Setup” button 226 of menu 220 launches the shoot setup screen FIG. 3A, which is used by the Admin/Producer or Technical Director (“TD”) to assign roles and access permissions to the users. Pre-production for a multicamera project is typically a laborious manual process. The logistics of getting equipment and personnel to the location and deploying them on-site is a substantial undertaking. The difficulty and complexity are amplified and security issues arise when crew members are working remotely from offsite.

The Shoot Setup feature is a core component of the AIRcloud™ system's provisioning and permissioning automation. This is where cameras, computer instances, connected equipment and personnel are securely provisioned and assigned for the project.

Using the Shoot Setup Screen 300 shown in FIGS. 3A-3E, a Producer (or Admin) uploads a background image or site plan for the project. Camera icons are chosen from the list of available resources and positioned in their appropriate spot. Operators from the available crew list can then be attached to the camera(s) for which they will be responsible. Compute instances and other equipment for switcher, playback, audio, graphics, et al can be provisioned and have personnel assigned. On-camera talent, on-site technicians, client and other roles can also be assigned in the Shoot Set Up interface. New Users can be invited to join the project by using the “add” (+) feature. Once the invitee creates their user profile they are added to the list of available personnel assets for the project. Cameras, Compute Instances and other connected equipment can be added to the available gear selection list by using the “add” (+) feature. A “Placeholder” for any asset can also be provisioned and later replaced.

FIGS. 3A-3E provide an example of a Shoot Setup. After login and selection of the project, “Shoot Setup” button 226 is selected in navigation menu 220. In FIG. 3A, a “Conference Room” site plan is selected from the list of available site plans from a “Site Plan” menu 302. Selection of this site plan displays a diagram 304 of a conference room with a stage/platform area and audience seating. The diagram may be generic or may be custom-programmed for a specific location. In FIG. 3B, AIRstation™ camera #3524 is selected from the available list of gear in Gear menu 308 and placed into position over the site plan, indicated as camera 310. Once positioned, the camera can be rotated to show direction and a production number may be associated with the camera. The positioning can be easily achieved through a drag-and-drop motion in which the Admin/Producer selects the desired gear with their finger (on a touchscreen), or a stylus, mouse, trackball, or similar interface, and drags it over to the desired location within the site plan. When a camera is selected, a switcher instance (Live Switching Instance 01 on the Gear menu) can be automatically provisioned. In FIG. 3C, “CAM 03” is the designation then assigned to camera 310 for the production. “User 02” (322) is then selected from the list of available crew in Crew menu 320 and connected to “CAM 03”. The act of assigning crew into job positions also enables permissions that allow access to information and other actions necessary to perform the assigned task.

Referring to FIG. 3D, selecting from Crew menu 320 and using the same drag-and-drop action, “User 26” (324) is assigned as Technical Director and “User 22” (326) assigned as an on-site technician. A similar process is followed for the remainder of the gear and personnel by simply dragging and dropping the gear and camera operators at the desired positions within the site plan. In the example completed set-up shown in FIG. 3E, five cameras 311-315, selected from Gear menu 308 are positioned around the auditorium stage, with a user assigned to each camera. “User 34” is shown as the Director/Producer, which may physically be located on-site or off-site. Additional functions and features that may be provided within the Crew menu include communication buttons for each crew member. For example, next to each crew member's identifier will be one or more button for instant voice communication, messaging, and/or e-mailing that person. This enables rapid communication between crew members to allow quick adjustments to be made as needed. Another feature that may be displayed in the Shoot Setup screen is camera status. Color-coded or other visually distinctive indicators may be provided for each camera and each crew member. For example, a green dot next to a camera or crew member means they are online and available for selection, while a yellow dot indicates offline and available for selection. A red dot can indicate that the camera or crew member has an expired subscription or is otherwise not available for selection. As will be apparent to those in the art, other types of status indicators may be used.

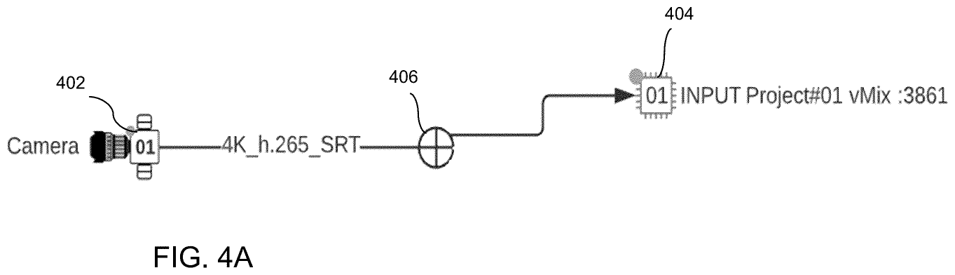

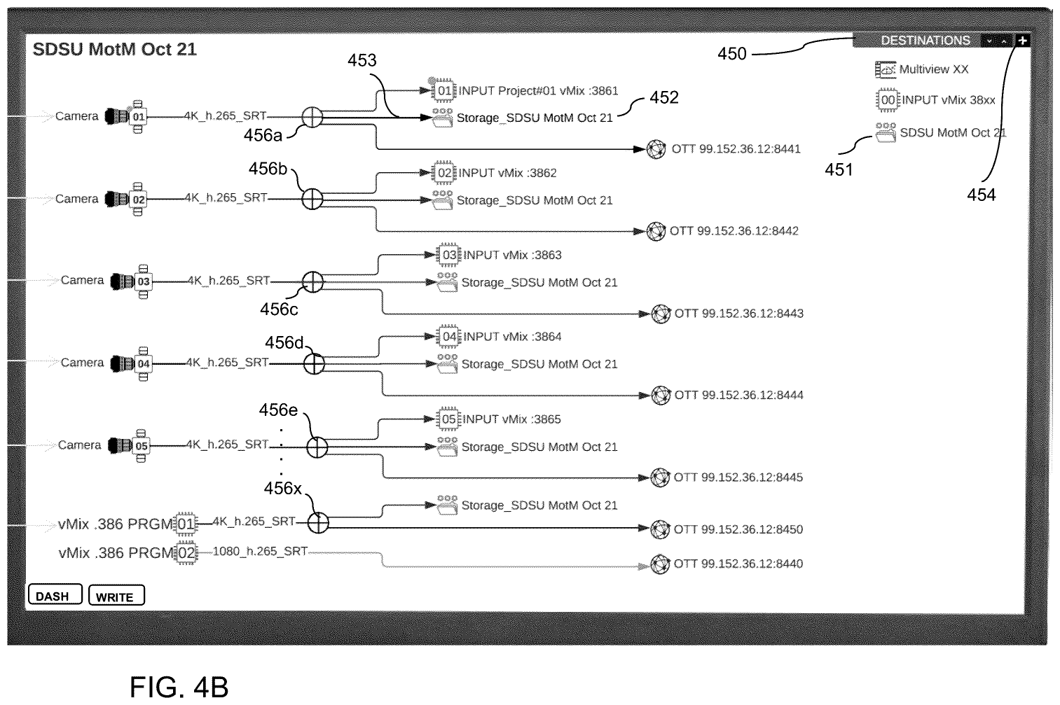

A powerful feature of the inventive AIR system is the automation that is triggered as a result of assets being provisioned and assigned. A single manual act can trigger multiple automatic actions. In one example, referring to FIG. 4A, when a camera platform icon is assigned a position within the site plan, a Switcher Instance can be automatically provisioned and the audio and video signals from the camera are automatically routed to a specific network input port (TCP/IP) on the Switcher Instance. In this example, Camera #1 (402) is routed at router 406 to Switcher Instance network input port: 3861 (404).

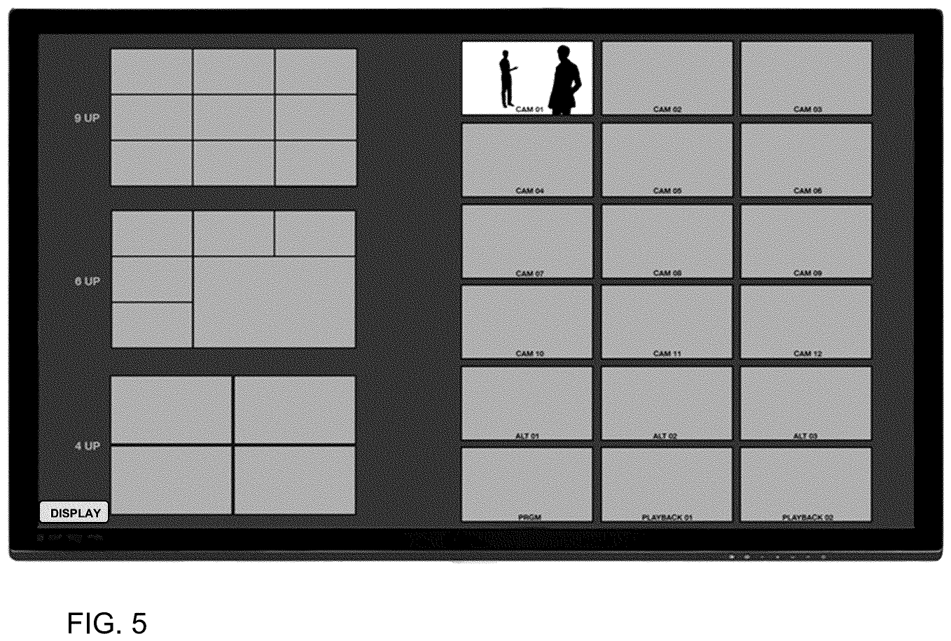

The result of the automatic routing process for multiple assets can be viewed by selecting the “Routing” button 221 in navigation menu 220. This displays a live video/audio routing screen, an example of which shown in FIG. 4B, with details about the cameras that have been assigned for the project. In the illustrated example, five cameras are displayed along with information about each camera, including the destination(s) of the camera output. When a camera is assigned on the Shoot Setup screen, a Multiview source is automatically created with the same name, as shown in FIG. 5. An Origin source is automatically created in the AIR hub (within integrated workflow management 106). When a Switcher instance is created on the Shoot Setup screen, a video switcher program output is automatically created as a source in the AIR hub and a Multiview source is automatically created from the video switcher output.

At this point in the workflow, when a Camera Operator (User) is assigned to Camera #1, permission for control of that camera is automatically configured. When the Camera Operator logs into the system and selects the camera for control, the IP address and appropriate permissions and settings for the camera platform auto-populates within the AIR mobile application.

For other users, their permissions will be similarly auto-populated. For example, a Technical Director controlling a Cloud Switching Instance is automatically assigned permissions for remote control of that instance when they are assigned the Technical Director role for a project. They are additionally automatically assigned permission to route any of the audio/video signals associated with the project.

This automation removes multiple manual steps in the setup process, saving time and reducing the chance of human error. Communications and notifications: If desired, notifications can be automatically sent to appropriate crew members when modifications are made to any aspect of the Project. Similarly, with the communications system, permissions for users are automatically provisioned and users are routed to their appropriate groups for real time communications once they are assigned a role on the project.

“Multiview” refers to multiple camera video feeds being displayed in one predefined space or screen. Multiview is common in a broadcast production truck or broadcast stage control room. Traditionally, each video feed is sent to an individual monitor rather than to an aggregated display of multiple video feeds on a single screen. Hardware, such as Blackmagic Design's video switchers, provide an aggregated view over a single output as a standard feature. However, the multiview feed is often unavailable to technicians outside a control room space.

The ability to view feeds from multiple cameras simultaneously in real time is critical to the production process. Producers and Directors require this capability in order to select the correct shot(s) for the program feed, set proper camera angles, prepare replays, view graphics, and other purposes. Other project technicians can benefit from viewing these real-time feeds, but this is rarely available due the expense and complexity of sending multiple feeds to multiple destinations. Camera operators are sometimes given a “program return” video feed showing the master program output, typically their own camera with graphics superimposed which they use to frame the shot appropriately to accommodate the graphic positioning. Camera operators are often unable to see what other cameras in a multi-camera setup are capturing in real time. The availability of such a feature would assist in adjusting framing, seeing events outside of direct camera view and anticipating framing needs. This is particularly applicable to camera operators who are not positioned directly behind the camera or off-site.

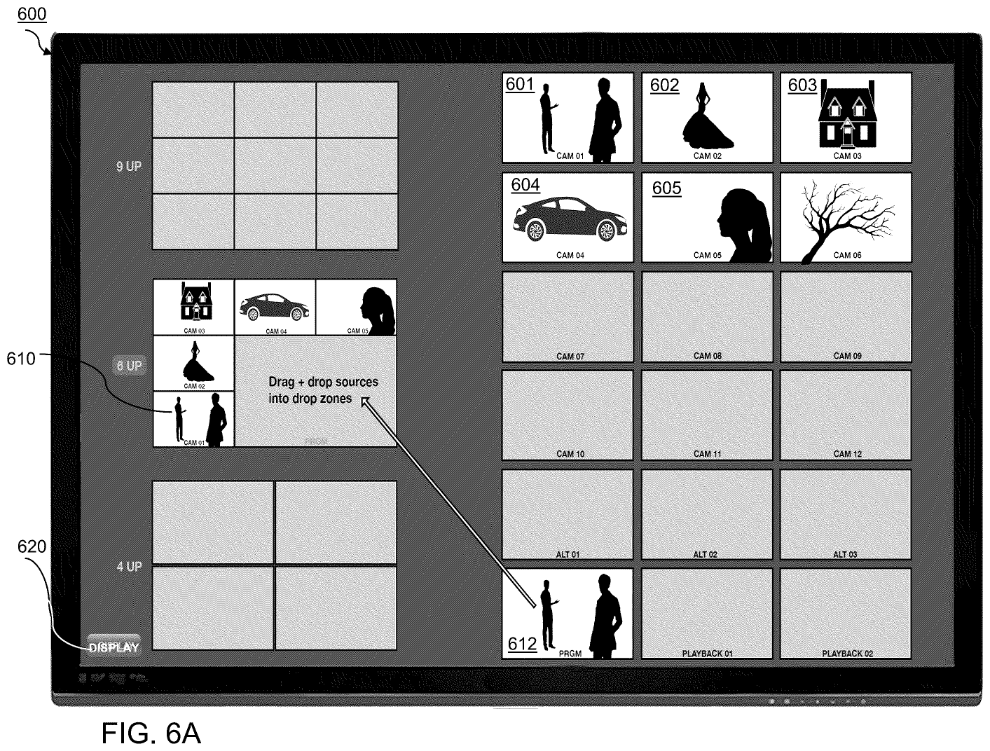

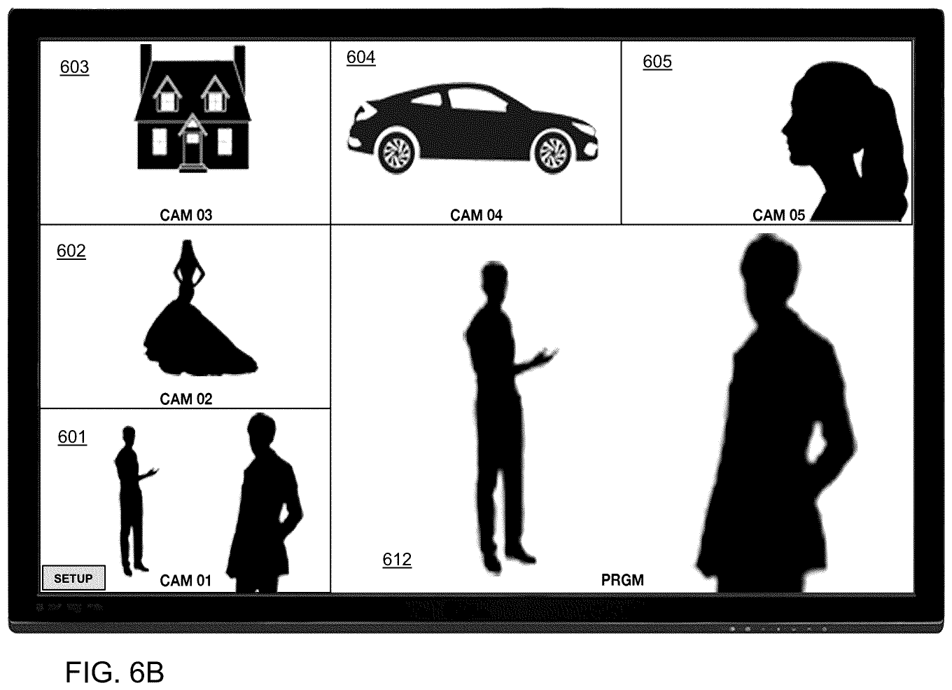

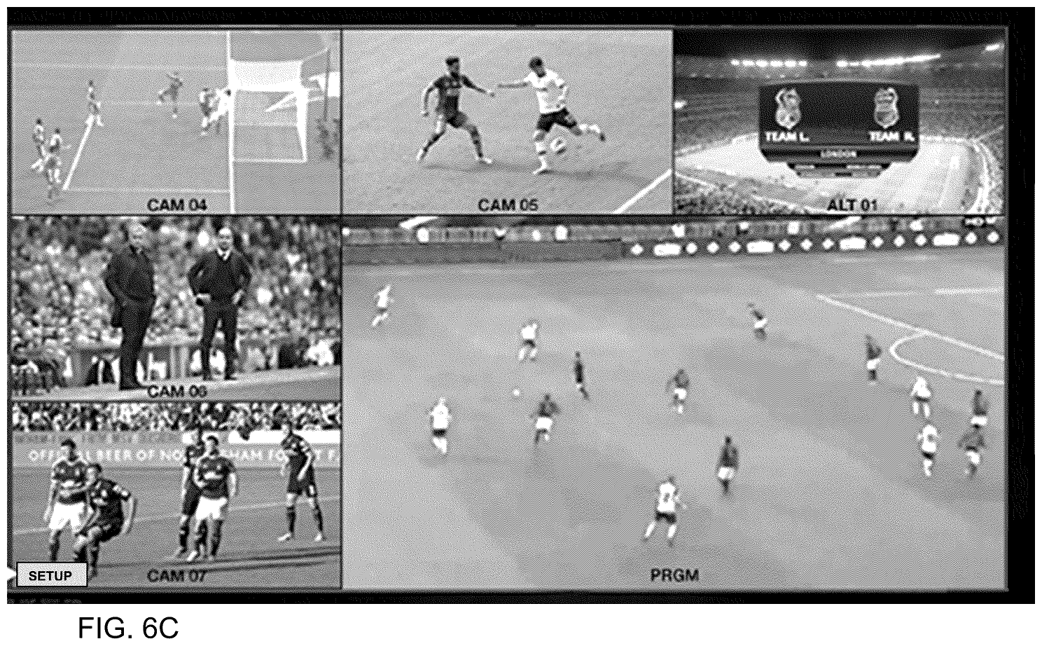

Using the inventive approach, entering the production phase, the user can select the “Multiview” button 230 in navigation menu 220 (FIG. 2A) to open the Multiview function, allowing the user to select from a preconfigured multiview or the available program video sources and condense them onto a single screen in a “multiview” window. Examples of multiview windows are diagrammatically illustrated in FIGS. 6A-6B. In one implementation, multiview is delivered over ethernet via a simple web browser window. Users can customize which video feed appears in each subsection or “dropzone” and display that configuration in a fullscreen view. Referring to the Multiview Setup screen 600 shown in FIG. 6A, video sources 601 to 605 (from “CAM 01” to “CAM 05”) can be dragged and dropped into a reduced display pattern. For example, display pattern options 4-up, 6-up, and 9-up are shown and available for selection by the user. These pattern options may be set as defaults, or customized options may be established via a setup feature. In the figure, a 6-up display 610 is chosen, with the feed from the primary switcher output being used for the program feed 612. After selecting the sources, clicking the Display button 620 on the Multiview Setup screen, opens a “6-up” display shown in FIG. 6B with videos from the selected sources. FIG. 6C provides an example of an actual 6-up Multiview stream for a football match.

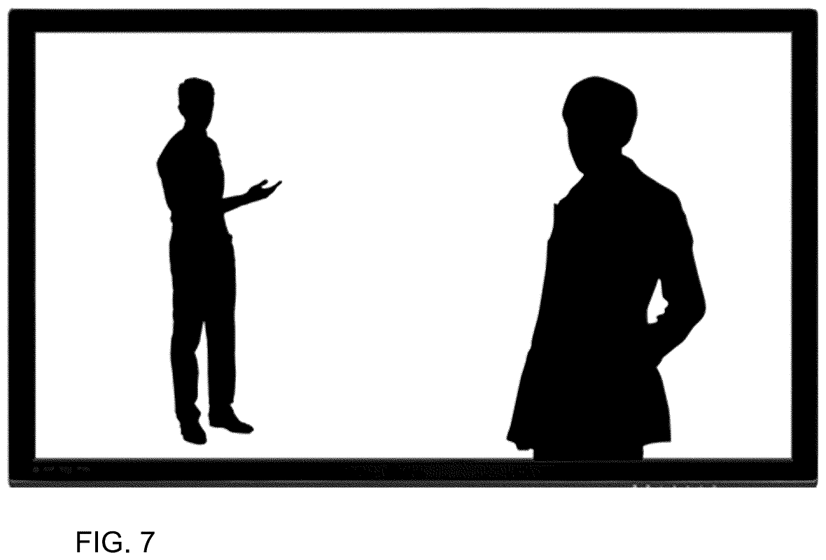

The “Program Feed” button 229 on the navigation menu 220 (FIG. 2A) opens a new window with the video stream. This feed can be sourced from the program output of the video switcher or from the end content distribution network (CDN). This feed can be used for multiple purposes including a “confidence return” for technical monitoring of the viewer's broadcast quality. As shown in FIG. 7, the Program Feed corresponds to the video displayed in FIG. 6B as program feed 612.

Establishing remote control of camera platforms can be complex. An uninterrupted control connection must be maintained, and latency must be kept to an absolute minimum. Disruption of control signals can have catastrophic results for video quality. Serial control connections are limited in their practical range. Conversely, IP-based protocols are not distance constrained but face challenges in traversing NAT (Network Address Translation) implementations and firewalls. Network admin privileges at the host location are usually required for port forwarding. Most organizations will not permit port forwarding since it opens their networks to security risks. These challenges make it difficult to establish camera platform control connections.

The inventive system's camera control function bypasses these issues with a preconfigured easy-to-use access link for a remote camera controller. Selection of the “Camera Launchpad” button 228 on the navigation menu 220 (FIG. 2A) opens a zero-configuration link between a remote control camera platform and an operator who, in this example, is using the WebRTC real time video and signaling protocol. WebRTC uses a function known as ICE (Interactive Connectivity Establishment) to allow direct connections to peers. ICE uses STUN (Session Traversal Utilities for NAT) and or TURN (Traversal Using Relays around NAT) servers to accomplish this. STUN is a protocol that allows discovery of a peer's public IP address and determines if there are any restrictions that would prevent peer-to-peer connectivity. If there are restrictions that prevent direct peer-to-peer connections, the connection will be relayed through a server using the TURN protocol. Relaying incurs additional latency, as there is at least one additional connection point or “hop” which makes it less desirable than STUN. This makes using TURN a secondary (fallback) method for remote connectivity. In some embodiments, the inventive system's remote connection may also be established using a virtual private network (VPN). The VPN system, while inherently different from WebRTC, acts in a similar fashion where the connection is automatically upgraded to a peer-to-peer connection. If peer-to-peer connectivity is not possible, an intermediary (relay) server may be used between the AIRstation™ and the mobile app. Although two methods of remote connectivity where referenced, the inventive approach is sufficiently flexible to work with other new and existing remote connectivity methods that enable NAT traversal.

Using the Camera Launchpad function, these complicated NAT transversal techniques are transparent to the user. Users follow three simple steps to gain access to a remote camera platform.

A camera operator logs in to the portal as described above to select the project to which they have been assigned, and then selects the camera for use on the Launchpad screen.

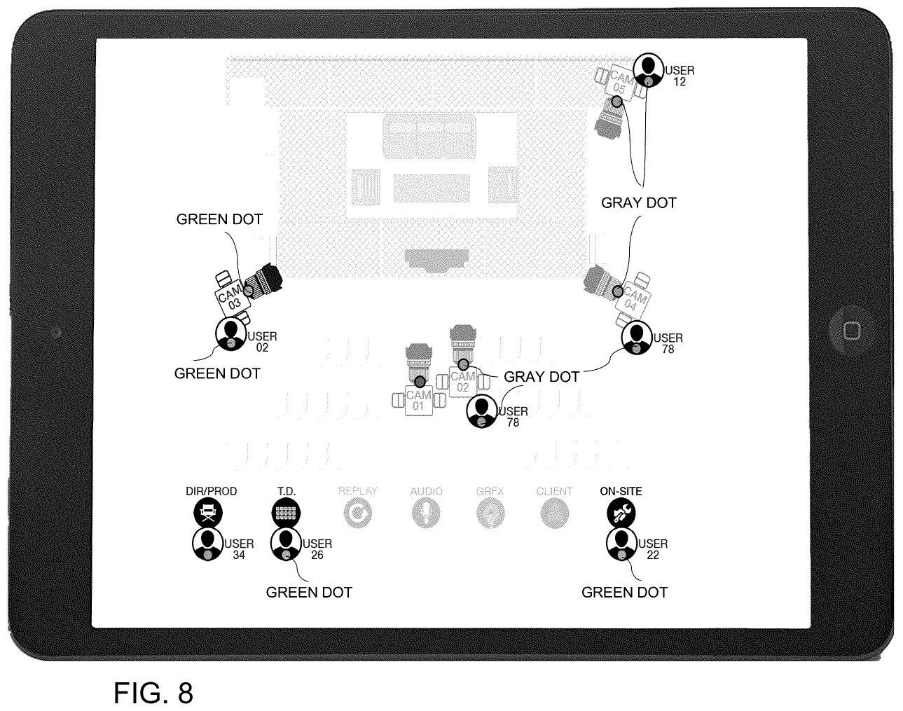

Referring to FIG. 8, on the camera control screen, a site map of the project is displayed along with icons for equipment and personnel involved in the production. This is a read-only version of the Shoot Setup screen with an overview of the location and the shooting scenario provides crucial information for camera operators who are not physically on site.

The Launchpad interface shows which cameras are authorized for user control by a combination of visual distinctions to indicators for online/offline status for the camera platform. Visual distinctions can be based on color coding alone or in combination with opacity, brightness, or patterns such as dashed lines. For example, units that are available and authorized for user control may appear as an icon with 100% opacity, while units not authorized for this particular user may be displayed with reduced, e.g., 50%, opacity. A green dot may be used to indicate the system is authorized and connected to the main controller. A yellow dot may indicate that the asset (camera) is authorized but not connected. A gray dot may indicate the camera is already under control by another user. A red dot may mean that the system is not authorized for external control, and a blue dot may be used to indicate that the system is connected but not assigned. A user can submit a request for permission to control a camera for which they are not yet authorized and that permission request can be automatically forwarded to an administrator for approval. This feature eliminates the need for manual entry of IP addresses and access codes, thus reducing the chance for human error and permitting fast unfettered access to the camera control hardware.

Clicking or double-clicking on a unit launches the application for operating that camera. In some embodiments, the application is described in International Publication No. WO 2021/195641, which is used in conjunction with the AIRstation™ robotic camera system. To control a camera platform (AIRstation™ or other), the user selects an authorized camera icon for control. The mobile device's browser then launches the AIR camera control mobile application via direct communication between the web browser and the mobile operating system. This may be accomplished through an advanced process known as “deep linking” where an “intent URI” (uniform resource identifier) is used to securely launch the mobile app. URIs are known by those of skill in the art for identifying logical or physical resources used by web technologies. Credentials for control will have been automatically provisioned and access has been pre-approved.

In the example shown in FIG. 8, a green dot (labeled “GREEN DOT”) associated with CAM 03 indicates that CAM 03 is online and available for selection by USER 02. When USER 02, also associated with a green dot, selects CAM 03, the AIR control mobile application is launched and credentials are automatically forwarded to allow control of the platform. Other users and cameras involved the example project are labeled according to the color coding scheme described above, thus providing a user who is viewing Launchpad interface information to facilitate teamwork in executing the project.

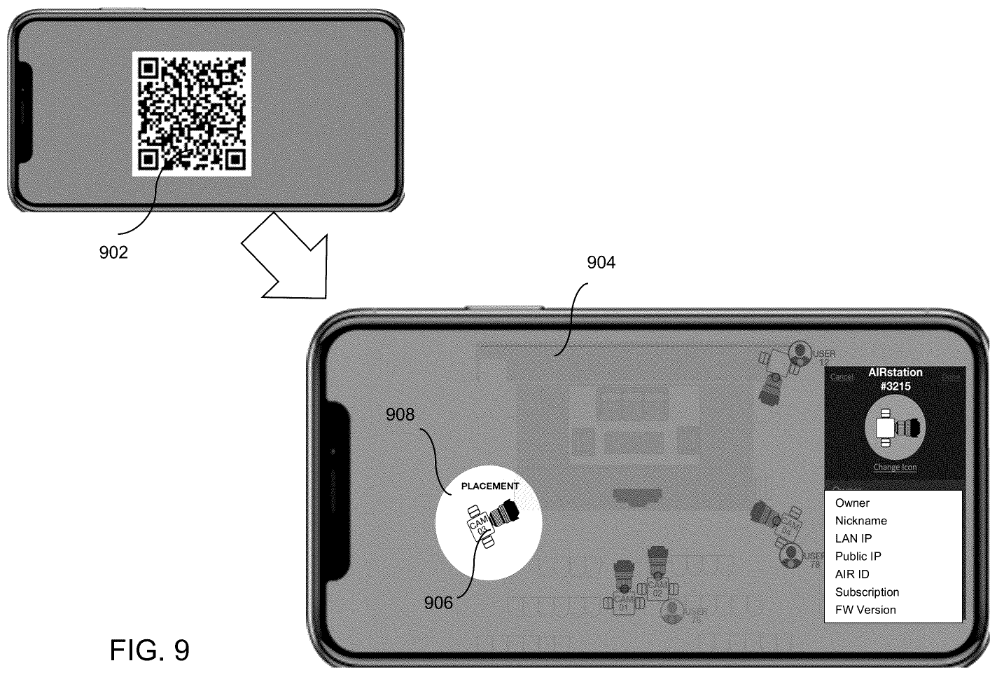

For the system to function effectively, camera platforms must be placed according to plan. To assist the on-site crew in placing the camera platforms in the correct positions, the system may use QR codes, bar codes, BLE (Bluetooth low-energy), Radio Frequency ID (RFID) tags, or other identification scheme that may be physically or electronically associated with the gear to provide links to display the predetermined site plan. For example, for system implementations utilizing AIRstation™-equipped camera robots, a QR code displayed on the back of the unit, when scanned, will show the technician exactly where the camera platform should be placed on the site. To illustrate, in FIG. 9, scanning QR code 902 will display a diagram 904 with the pre-planned location of the camera 906 within the site plan, shown here withing a highlighted circle 908 for enhanced clarity. Additional information may also be displayed such as setup information including designated lens type and setting, camera height, along with the appropriate networking parameters and permissions that have been assigned. Camera identification information may also be displayed. For equipment that has not been preassigned, a simple one-click interface can route the “where does this go?” question to the appropriate administrator. In other embodiments, the camera (AIRstation™ or other camera system) may have an associated QR code, or similar code, that can be scanned by an in-field tech to initiate a camera connect screen that displays the predetermined camera assignment and placement. This information can then be used by the offsite user to provide instructions to the in-field tech for desired positioning of the camera.

Video production often requires video and audio signals to be routed to more than one destination. Routing of audio and video signals is traditionally handled by dedicated A/V specific hardware. See, e.g., U.S. Pat. No. 9,191,721, of Holladay, et al., the disclosure of which is incorporated herein by reference. Companies such as Haivision (Montreal, QC, Canada) have improved upon this idea with products like the Haivision Hub™, a hardware/software product which allows data streams in their SRT (Secure Reliable Transport) format to be routed to various destinations via a simple interface. The drawback to the Haivision Hub™ is that it is designed only to ingest streams transported using the SRT protocol.

Selection of the “Routing” button 221 in the navigation menu 220 takes the user to an AIRhub™ screen, a matrix router for live video and audio assets, an example of which is shown in FIG. 4B. This AIRcloud™ A/V router (designated as 456a . . . 456x) will ingress and egress A/V feeds in a multitude of formats and protocols including SRT, RIST, RTMP, and others using a simple drag to connect interface. AIRhub™ also allows routing of video and audio feeds to switcher instances, replay instances, digital object storage devices, and/or other end points.

To modify or add additional sources and destinations, the user adds an end point (451) from the available destinations (450), positions that end point in the routing area (452) and then drags a connector (453) from the source to that destination. Additional destinations end points can be configured and added to the available list by selecting the “add destination” feature (454). For switcher outputs, the video and audio are similarly routed by drag and connect. This feature can be used to route camera feeds into switcher instances, replay instances, graphics programs, distribute program outputs, and/or raw camera feeds to CDN, route camera feeds to digital storage end points, etc.

The inventive AIRcloud™ system's routing scheme also records these sources and destinations as metadata that can be recalled at a later date for media management, digital rights management, and other purposes.

Selecting of the “Virtual Workstation” button 227 in the navigation menu 220 (FIG. 2A) of the AIRcloud™ Portal launches capabilities for controlling virtual workstations. A user with appropriate permissions can launch a remote desktop interface for control of cloud-based or offsite compute instances. These instances can run computer-based video and audio switching and mixing software, animation software, editing software, live graphics contribution, video playback/slow motion, and more.

Examples of appropriate computer-based video switching and instant replay software that may be used with the inventive system include vMix™ (from StudioCoast Pty Ltd., Robina, Queensland, AU), OBS (Open Broadcaster Software, from the OBS Project, an open source software distributed under General Public License, v2.), VizVector (from Vizrt), SimplyLive Replay (from Reidel Communications). Editing software examples include Adobe® Premiere®, Apple® Final Cut Pro®.

The inventive AIRcloud™ system enables more complex and sophisticated routing and switching because it is not constrained by traditional video hardware limitations of inputs, outputs, and layers. The system can expand exponentially on demand by daisy-chaining compute instances together. Furthermore, it is not constrained by geography.

The ability to communicate with all team members simultaneously in real time is critical to the production process. Dedicated intercom systems from multiple manufacturers exist for this purpose (Clear-Com, RTS, et al) but they are tied to proprietary hardware, limited in range, and are complicated or impossible to deploy to crew members working remotely. For remote access users there may also be challenges to preserving secure communications.

Selection of the “Comms” button 224 in the navigation menu 220 (FIG. 2A) launches a communications (“Comms”) function that allows authorized users to communicate via voice and text with other team members in real-time on any internet connected device. In one implementation, full duplex audio may be included to allow for intermittent voice communication to the rest of the production team. The Comms function is provisioned automatically when a crew member is assigned a project role, integrating with the overall project setup for simple all-in-one deployment. The Comms function facilitates advance preparation and shoot-day communications. Groups can be created, for example, the camera operators who will be on-site for the shoot can set up a group for quickly linking to all members. In some embodiments, the Comms function may be compatible with standard communications operating systems such as Apple® IOS, Android®, Mac®, Microsoft® Windows® and other popular communications formats.

Once principal photography is complete many media projects must go through a post-production process. This can involve assembling an entire program from the beginning using camera original footage and/or working from a live-switched program master modifying and fine tuning the choices that were made in real time. This process can also include extracting highlight clips from the program feed and/or individual camera recordings, adding graphics and animation, modifying the program audio, repurposing the captured content for new purposes, as well as many other use cases.

The editing process typically involves aggregating video, audio, and graphic assets into a media storage device attached to an edit workstation. If multiple editors are working on a project, those assets and edit system configurations must be duplicated across all workstations. This is frequently a time-consuming, laborious, and potentially error-prone manual process. A substantial portion of an editor's labor is spent manually aggregating assets, manually categorizing them, manually managing the media, manually uploading edits for review, and then manually interpreting and organizing the feedback from reviewers for changes. Version management of assets can also be a problem.

EditShare™ (Watertown, MA) and others offer products that improve certain aspects of the edit process by enabling media to be shared across a Local Area Network (LAN) or, in some cases, duplicated across a Wide Area Network (WAN). Frame.io (an Adobe® company, New York, NY), is one example of a source of video review and collaboration platform that provides improved media management as well as the media ingestion process through their C2C (Camera-to-Cloud) product. The main drawback to these products is that they still require significant manual intervention as well as manual verification that the file was transferred securely. They also require that the workflow adhere to the duplication model, distributing the media to multiple endpoints for use.

The inventive AIRcloud™ system's post processing function removes the need to duplicate media by virtualizing the entire post-production process. Instead of sending media to various computer storage endpoints for use, the AIRcloud™ system brings the compute power and the editor to where the media resides. By concentrating the media in cloud-based storage with direct connection to cloud compute instances, any editor that logs into the virtual compute instance(s) will have access to identical assets without the need for duplication. The centralization of the post-process reduces the need for media duplication and helps streamline version management. It also ensures that the edit system configuration and media assets are the same across all editors and contributors to the editing process.

The integration of the AIRstation™ camera platform with the AIRcloud™ storage allows for media uploads from on location to cloud storage instances. It also provides bit-level file integrity verification to ensure the entire file has been uploaded and that it is an exact copy of the original. Support is also provided for asynchronous uploads to allow for a file upload to start, pause and continue uploading at a later time.

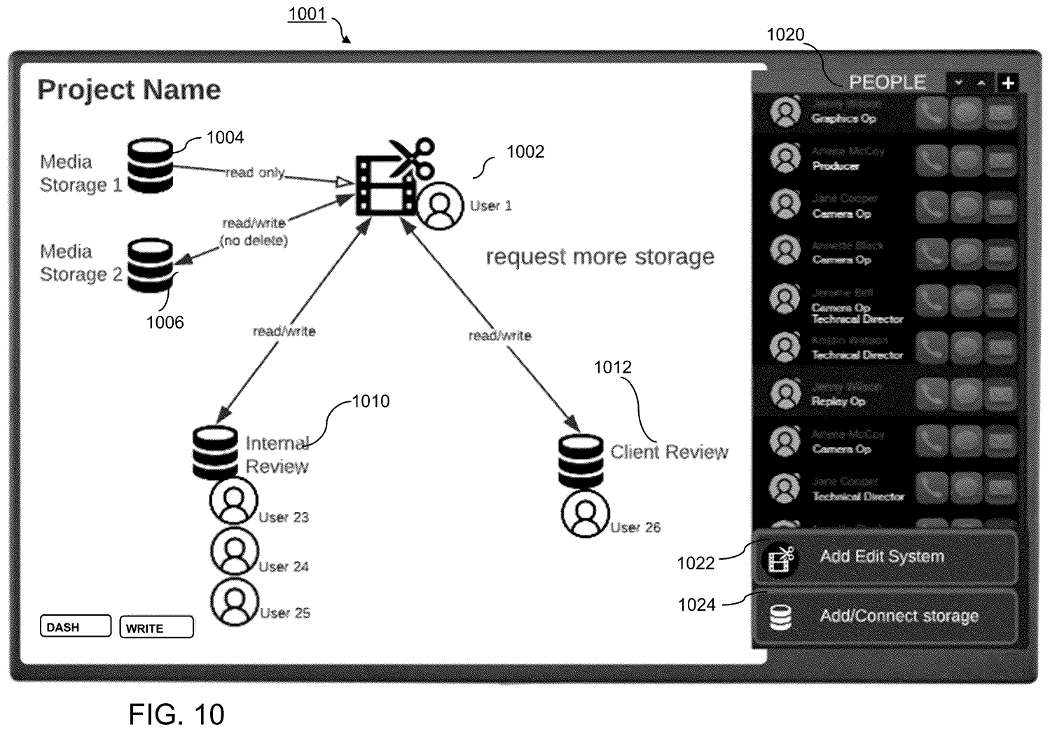

Selection of the “Post Setup” button 223 in navigation menu 220 (FIG. 2A) launches Edit Setup screen 1001, a sample of which is provided in FIG. 10. For workflow management, the editing process can be provisioned with instances, personnel and permissions using the methods similar to those used in live production. Project media folders from the shoot will be auto-authorized for the editor to read and/or write. Additional media folders can be auto-created for Internal Review and Client Approval. Virtual edit instances can be created, assigned to editors along with access to the video, audio, animation, graphics, data, and text assets necessary to complete the project. In the illustrated example in FIG. 10, editor 1002 has been assigned video and associated data stored in two media folders, the first folder 1004 designated as read only, and the second folder 1006 designated as read/write (no delete). As shown on the screen, editor 1002 is the active user. On the right side of the screen is displayed a menu 1020 of people (users) who participated in the project. Below the menu 1020 are buttons that a producer may use to provision an edit instance or add or connect to additional media storage (1024) for use by the editor 1002. These project participants can be automatically populated into this menu using permissions activated at the beginning of the project or they can be dragged, dropped or deleted by the producer according to their preferences. The producer can select a user as needed to discuss actions or explanations for that person's contribution to the project, with various communications functions available to select phone, text, or email communication. Reviewers may be auto-created when the editor job is assigned. These users are authorized reviewers for project change notes and approvals. Once an edit is ready for review, selection and viewing by users associated with review tasks can be enabled. Completed edits can be automatically generated and reviewers notified when content is available for their feedback and approval. This unified system also allows for automation of the review and approval process.

FIG. 2B illustrates an exemplary post-production process flow, where in step 250, the project administrator 105 enters information identifying or more editors and managers to be involved in the project. This will enable the delivery of assets to the identified personnel. This step may also be used for modifying the original entries. In step 251, the administrator creates assignments, or “jobs,” for the persons identified in step 250. One or more jobs may be identified, with the same team or a different team assigned to each job. The digital assets that have been generated for the project are uploaded to the cloud in step 252 for access by the assigned users, and in step 253, the uploaded assets are assigned to the jobs created in step 251. In step 254, the editor(s) are assigned to the job(s), giving them access to the digit assets that correspond to the job. The editor accesses the digital assets to carry out their assignment of editing the digital assets corresponding to their assigned job (step 255) and, upon completion, submits a status update to the workflow management module 106 to generate a notice that the job is ready for review. In step 257, the manager or administrator reviews the edited content to determine whether it is complete. At this point, notification that edited content is ready for review may also be sent for client review via client review and collaboration module 108. If the manager, administrator, or the client determines that the edited content is not acceptable, it is returned to the editor in step 255 and a notice is sent to advise the editor that additional work is required. If the edited content is considered complete by the reviewers, the manager/administrator makes an entry via the interface 110 to update the status as “completed” in step 258. In step 259, the completed asset is downloaded for the intended “performance”, i.e., broadcast or display.

Once an edited version of a project is completed, the editor 1002 can designate that file as “ready for review”. Text based notifications can be automatically generated for reviewers. Reviewers (internal 1010 and client 1012) can then log in to the inventive AIRcloud™ system where they will be directed to the file for edit review. A file playback interface allows for time-marked feedback. Timestamped notations are important for clarity. The time-marked feedback is available to all reviewers as well as approved project personnel. Indexed, timestamped, and collated feedback viewable by all contributors and the project editor(s), greatly streamlines the review process.

Aggregation, classification, storage, and retrieval of media assets is one of the more labor intensive portions of the post-production process. These are traditionally manual processes performed by a combination of producers, editors, and assistant editors. While some automation of image classification has been made possible in recent years through improved Machine Learning algorithms, the methods to trigger that process remain cumbersome.

The AIRcloud™ Media Asset Management (“MAM”) system augments existing post-production methods by automating the classification, movement, storage and retrieval of assets. This function can be selected using the “Media” button 222 in navigation menu 220. A traditionally fragmented process is centralized and standardized through a unified process that enables tight classification, tracking, and automated movement of media assets.

The AIRcloud™ MAM feature enables searching for assets by name, date, format, client, project, or other identifiers, tagging assets with keywords and/or additional metadata, manual and automated movement of assets, automated modifications of permissions, copying of assets to the edit system, and moving assets to archive or storage. From the moment an asset enters the system, its movement through routing, switching, storage, and editing can be tracked via this feature. This comprehensive tracking of assets throughout their lifecycle adds an unprecedented level of detail to asset metadata.

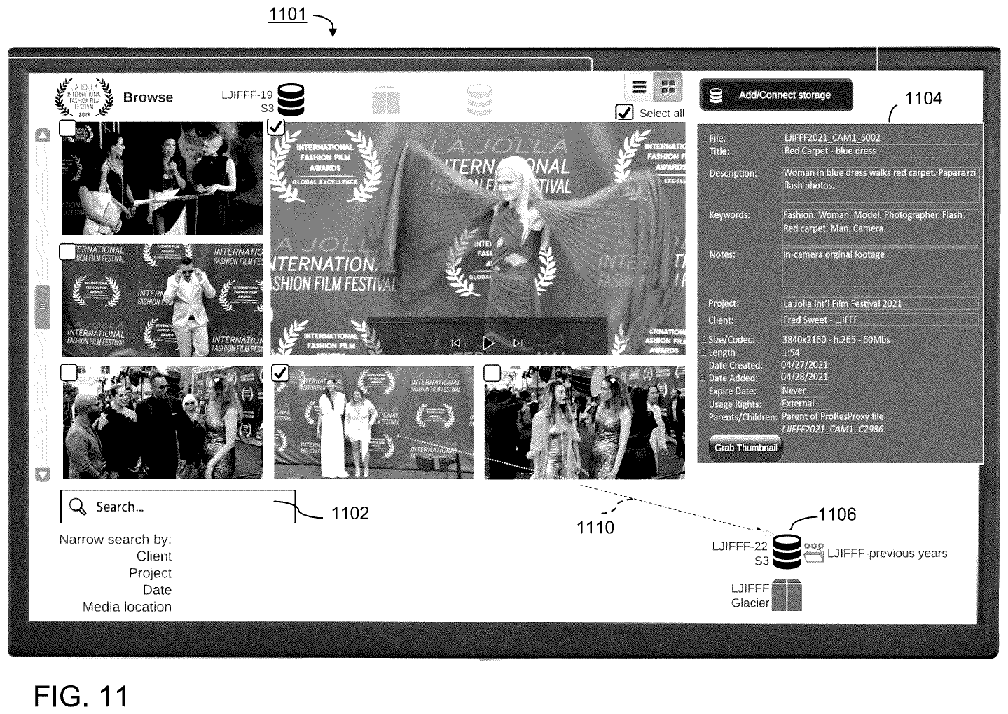

FIG. 11 provides a sample screen shot of the MAM feature for a film festival. Video assets may be selected by clicking on the different thumbnails. The MAM screen 1100 includes a detail pane 1104 that provides information about a selected image, keywords that can be used to search the image, notes describing the image, the project name and client, and other information that may be useful to identify or select video or audio files associated with the project. Search box 1102 allows entry of search parameters. Assets may be moved into one or more folders 1106 for storage by dragging and dropping the image thumbnail to the folder as indicated by arrow 1110.

Artificial intelligence (AI)-assisted asset identification and categorization can be automated for assets ingested into the system to extract useful information from the video and audio. The approach of the AIRcloud™ system drastically simplifies the use of automatic categorization tools that use machine learning and artificial intelligence for functions such as object detection, keyword tagging, face detection, video segment identification, as well as computer vision analysis of human performance, body mechanics, emotion perception and more. Keywords and metadata gleaned from these AI tools are a critical tool for finding, organizing, and securing media assets. Additional AI-assisted functions may employ advanced audio analysis and annotation. The inventive AIRcloud™ system may also include automatic speech to text transcriptions by integrating a third party transcription application. This capability can further streamline the process of uploading video/audio files and then downloading results. In addition, speech detection function may be used to trigger other commands within the system, for example, the mention of a particular product or person may trigger an instruction to insert into the video an image of the mentioned product or person.

With online storage, nearline backup, and offline archival long term storage connected to the system, automated backup and archiving of assets can be programmed upon project completion.

The MAM function also integrates with the approval and review process, storing all project change notes and associating those with the assets. Once an asset or project has been marked as “approved” by reviewer(s), various tasks necessary to complete, distribute, and archive the assets and/or projects for the production can be automatically triggered. Indexing of assets and projects allows for simple retrieval of complete offline archived assets by issuing a “restore project” command.

The media asset management (MAM) function within the inventive AIRcloud™ system is capable of integrating via API with third party asset management systems such as Frame.io (Adobe®), catDV™ (Quantum Corporation), and others.

Existing third party asset management systems such as Frame.io have similar systems to the AIRcloud™ system's MAM function, however, they lack integration into the entire production/post production workflow, missing the provisioning portion, cloud instance routing, storage interconnection, automated permissions and more.

Metadata, including but not limited to, pan/tilt/roll positioning from motor encoders, velocity and position data from the camera platform Inertial Measurement Unit (IMU), lens data for focus and aperture, zoom motor data on lens focal length; camera metadata including ISO, f-stop, recording format, codec, bitrate, frame rate, white balance, color profile, shutter angle, exposure value offset, RGB information, auto focus settings, audio levels; user pan/tilt gesture information, user zoom/focus/aperture information; switcher video & audio source and graphic selection information can all be captured in real time for immediate use, in conjunction with the MAM function, or leverage the metadata for other post-production processes. These and other camera features and functions are described in the aforementioned International Publication No. WO2021/195641, which is incorporated herein by reference. This information can be used as a data set to improve system performance, train autonomous systems, and automate the production process.

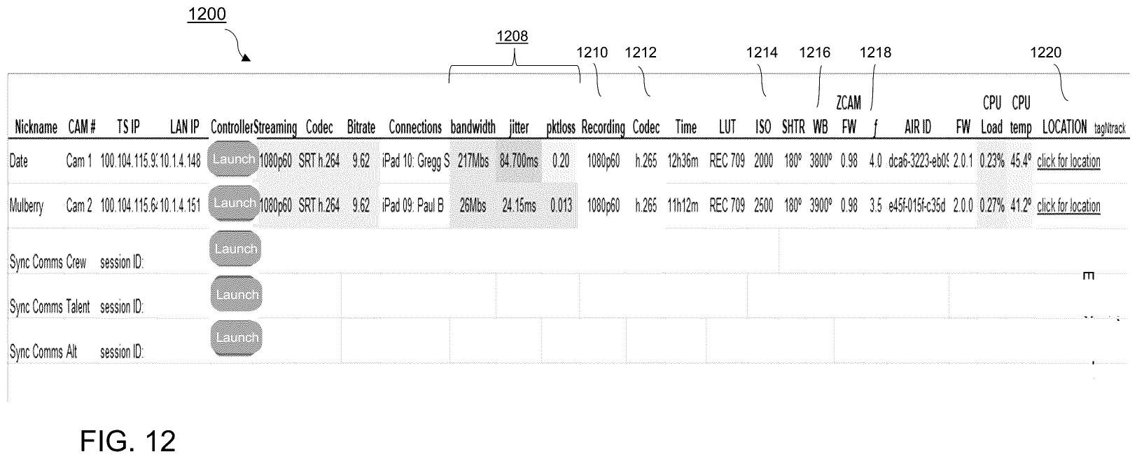

The statuses of all connected AIRstations™ as well as all deployed virtual compute instances can be displayed on the Master Status Dashboard (“MSD”) screens. FIG. 12 provides a sample screenshot of the MSD 1200. This dashboard displays all camera settings, CPU status, connection conditions, stream health 1208 (bandwidth, jitter, packet loss), crew communications as well as other system performance data in real time, or near real time. Examples of camera settings that may be displayed on the MSD include recording format 1210, codec 1212, white balance 1216, ISO 1214, f-stop 1218, geographic location 1220, and others, as shown in the figure. Additional examples of statuses that can be reported on the MSD include memory, CPU, available storage, recording status indicator, and uptime. The utility of the MSD screen is that at a glance, the settings and statuses of multiple platform components can be instantly seen to allow for confirmation or adjustment of various settings. The Master Status Dashboard can also be accessed by a technician anywhere in the production chain, enabling unprecedented performance visibility across the entire broadcast workflow. This addresses the common problem of a video failure on contribution end of the pipeline being undiagnosable by technicians on the content distribution end.

The present disclosure is to be considered as an exemplification of the invention and is not intended to limit the invention to the specific embodiments illustrated by the figures or description below.

1. A platform for managing video production workflows, the platform comprising:
an interface in communication with a network, the interface configured for entry of and transmission of instructions to and receiving information from a plurality of modules, each module in communication with the network, the modules comprising:
an admin module configured to provide instructions to other modules and receive status information from the other modules;
an offsite camera control module;
a remote editing module; and
at least one digital file source in communication with the network;
wherein the admin module comprises a user interface (UI) that is used by a project manager to assign jobs, access and distribute one or more digital file, and to communicate with platform users, and wherein the interface is further configured to deliver a completed video production to a content distribution network (CDN) in communication with the network.

2. The platform of claim 1, wherein the platform users comprise one or more of an administrator, the project manager, a producer, a director, a technical director, a camera operator, an audio operator, on-screen or voice-over talent, and a client.

3. The platform of claim 1, wherein instructions and information are configured to trigger one or more automated action within one or more of the plurality of modules and the at least one digital file source.

4. The platform of claim 1, wherein the one or more digital file comprises one or a combination of an image, a sequence of images, an audio, and metadata describing one or more of the image, the series of images, the audio, and information relating to creation of the one or more digital file.

5-6. (canceled)

7. The platform of claim 1, wherein the plurality of modules further comprises one or a combination of a machine learning module configured for artificial intelligence (AI)-assisted asset identification and categorization, a remote production module configured for managing broadcast of the video production to the CDN, and a client review and collaboration module configured to provide edited content to a client to review and accept or reject the edited content prior to delivering the completed video production.

8-11. (canceled)

12. The platform of claim 1, wherein the at least one digital file source is one or a combination of a camera configured for control via a remotely-located camera operator, wherein the remotely-located camera operator is in communication with the interface, and an audio recorder.

13-14. (canceled)

15. The platform in claim 1, wherein the admin module is further configured to perform one or more of assigning access limits for controlling access to elements within the platform and the one or more digital file by each platform user as required for the platform user's assigned job, and collecting status information for platform components and generating a master status dashboard (MSD) to display status and settings for one or more of the at least one digital file source, communications, and performance data in real time.

16. (canceled)

17. The platform of claim 1, wherein the at least one digital file source comprises a plurality of digital file sources, wherein each digital file source is associated with a unique code for establishing a link to a predetermined site plan.

18-20. (canceled)

21. The platform of claim 1, wherein the remote editing module is configured to manage a workflow for jobs comprising editing, reviewing and finalizing the project, wherein the remote editing module is further configured to deliver a digital asset to a designated platform user when a job is assigned to the designated platform user.

22. A method for managing video production workflows over a network, the method comprising:
providing an interface configured for entry of and transmission of instructions to and receiving information from a plurality of modules, each module in communication with the network, the modules comprising:
an admin module configured to provide instructions to other modules and receive status information from the other modules;
an offsite camera control module;
a remote editing module; and
at least one digital file source in communication with the network;
wherein the admin module comprises a user interface (UI) that is used by a project manager to assign jobs, access and distribute one or more digital file, and to communicate with platform users; and
delivering a completed video production to a content distribution network (CDN) in communication with the network.

23. The method of claim 22, wherein the platform users comprise one or more of an administrator, the project manager, a producer, a technical director, a camera operator, an audio operator, and a client.

24. The method of claim 22, wherein instructions and information are configured to trigger one or more automated action within one or more of the plurality of modules and the at least one digital file source.

25. The method of claim 22, wherein the one or more digital file comprises one or a combination of an image, a series of images, an audio, metadata describing the image, the series of images, or the audio,

26-27. (canceled)

28. The method of claim 22, wherein the plurality of modules further comprises one or a combination of a machine learning module configured for artificial intelligence (AI)-assisted asset identification and categorization, a remote production module configured for managing broadcast of the video production to the CDN, and a client review and collaboration module configured to provide edited content to a client to review and accept or reject the edited content prior to delivering the completed video production.

29-32. (canceled)

33. The method of claim 22, wherein the at least one digital file source is one or a combination of a camera configured for control via a remotely-located camera operator, wherein the remotely-located camera operator is in communication with the interface, and an audio recorder.

34-35. (canceled)

36. The method of claim 22, The platform in claim 1, wherein the admin module is further configured to perform one or more of assigning access limits for controlling access to elements within the platform and the one or more digital file by each platform user as required for the platform user's assigned job, and collecting status information for platform components and generating a master status dashboard (MSD) to display status and settings for one or more of the at least one digital file source, communications, and performance data in real time.

37. (canceled)

38. The method of claim 22, wherein the at least one digital file source comprises a plurality of digital file sources, wherein each digital file source is associated with a unique code for establishing a link to a predetermined site plan.

39. (canceled)

40. The method of claim 22, wherein the admin module is further configured to collect status information for platform components and generate a master status dashboard (MSD) to display status and settings for one or more of the at least one digital file source, communications, and performance data in real time.

41. (canceled)

42. The method of claim 22, wherein the remote editing module is configured to manage a workflow for jobs comprising editing, reviewing and finalizing the project, wherein the remote editing module is further configured to deliver a digital asset to a designated platform user when a job is assigned to the designated platform user.
